(19) United States
(12) Patent Application Publication
(10) Pub. No.: US 2008/0049946 A1
(43) Pub. Date: Feb. 28, 2008

(54) SELF-PACED IN-SITU AUDIOMETRY

(75) Inventors: Otto Hermann Heller, Gerbrunn (DE); Agnes Herta Anneke Opp-Enzinger, Untereisenheim (DE)

Correspondence Address: PEARNE & GORDON LLP, 1801 EAST 9TH STREET, SUITE 1200, CLEVELAND, OH, 44114-3108, US

(73) Assignee: Phonak AG, Staefa (CH)

(21) Appl. No.: 11/466,116

(22) Filed: Aug. 22, 2006

(51) Int. Cl. H04R 29/00

(52) U.S. Cl. 381/60

(57) ABSTRACT

Measuring the hearing ability or the diagnosis of the hearing loss of a person can be achieved by the recognition of a plurality of sound samples by said person. The initiation of the sound samples to be recognized is performed by said person itself. In other words the various sound samples at different frequencies or for different sound types and different sound pressure levels are initiated by the person whose hearing ability or hearing loss is to be determined. The sound samples are generated in situ, which means within a hearing aid worn by the person.

The present invention refers to a method for measuring the hearing ability or for the diagnosis of the hearing loss of a person according to the introduction of claim 1 and to an arrangement for the diagnosis of a hearing loss of a person.

The invention relates to the field of fitting diagnostics. For about ten years in-situ-threshold measurement is offered by some hearing aid manufacturers for pre-setting the hearing aids. This means that the hearing aid produces the stimuli and is used as audiometrical transducer. The result of the measurement reflects the hearing loss and specialties of the acoustical coupling. This is wanted although separation of acoustic coupling effects and hearing loss is not precise.

The method which is to be applied for measuring the hearing threshold mimics the methods which are applied with clinical audiometers. During the mentioned method the audiologist uses a kind of bracketing procedure to determine the lowest audible sound pressure level at a particular frequency. For this purpose the end user or the person for which the hearing loss is to be determined must stay attentive without interruption in order to hear if a sound is audible or not. Usually, a plurality of sound samples are initiated by the audiologist, as e.g. at least three or four sound samples at least four different frequencies.

The disadvantage of this solution is that the end user must maintain a high level of auditory attention in order not to miss any audible sound. In other words, the end user must stay attentive for at least 15 or more sound samples, which is rather stressful, tiring and as a consequence often leads to imprecise measurements. This is especially true if the end user is e.g. a child or any other person with difficulties to concentrate over extended periods of time. In addition, the difficulty to maintain constant attentiveness is particularly detrimental in remote hearing test and fitting processes, e.g. over the internet, where the audiologist does not have visual control of the state of attentiveness of the test person, or in self-test and self-fitting situations, where the person performs a particular test or fitting method without any supervision of a professional in the field.

Therefore, an object of the present invention is to improve the above mentioned methods with the goal of enhancing the quality of the respective results, which means in particular to improve and keep constant the attention of the end user or the person of which the hearing loss is to be determined during the recognition of the audible sound samples at the various frequencies.

In other words the problem to be solved is the inefficient handling of auditory attention in in-situ threshold measurements. Unnecessary fatigue and decreased precision of the measurements should be avoided by proposing an appropriate improvement of the known method.

According to the present invention a method for measuring the hearing ability or for the diagnosis of the hearing loss of a person is proposed according to the wording of claim 1.

The inventive method proposes that the initiation of sound samples to be recognized by the person is performed by the person itself. In other words the various sound samples at different frequencies and different sound pressure levels are initiated at least mainly by the person whose hearing ability or hearing loss is to be determined. Furthermore, it is proposed that the sound sample is acoustically generated in situ, which means within the hearing device worn by the person. This can be done be a sound generator inside the hearing device or by feeding the sound sample into the hearing device electrically or wirelessly in order to avoid all calibration issues which relate to the usage of an external loudspeaker generating the sound.

The proposed inventive method is of course not restricted to commonly used and worn hearing devices, but is also applicable to any kind of hearing aids, middle-ear implants, cochlear implants, etc., which are worn by the person.

According to a possible realisation of the inventive method it is proposed that the initiation of the sound sample is effected manually by touching a push-button, a touch-screen or the like. In addition it could be advisable that from time to time samples are initiated with definitely no sound pressure level for creating so-called fake samples or blind samples.

The initiation can be effected on a display or touch-screen displaying at least one object which stands for a certain sound frequency—or more generally for a certain sound type, e.g. a phoneme, a kind of noise etc.—, upon touching the object the sound sample with the sound frequency—or of the respective sound type is initiated.

Within hearing tests e.g. on the internet such as e.g. from the Hoerforum, Siemens, etc., self-initiated hearing tests are offered, in which a person of whom the hearing ability has to be determined can initiate the test. But once the first test sample being initiated the following test cycle is performed automatically, which means after each hearing test sample being recognized by the person, the next one will be initiated automatically. In other words within the known hearing tests the same problem will occur as above described in relation to the prior art. It is therefore important that at least most of the sound samples to be recognized by the person are performed by the person itself. Furthermore, as proposed according to the present invention, it is preferred that the sound sample is created in situ, which means within the hearing device worn by the person.

Further possible options for the inventive method are characterized within one of the dependent claims.

Furthermore, according to the present invention an arrangement is proposed according to the wording of claim 11. One arrangement as proposed according to the present invention comprises preferably a touch-screen displaying at least one object which stands for certain sound frequencies, and which makes associations to a person for certain sound frequencies. Furthermore, the arrangement comprises a sound sample producing device, which is operable upon touching the object which is displayed on the touch screen. The at least one displayed object may be an animal, a vehicle, an audio sample creating object, etc. etc.

According to a further embodiment of the present invention it is possible that a plurality of the same or similar objects is displayed or a plurality of different objects.

Again, according to one possible embodiment the one object or each of the plurality of the various objects are connected to the sound sample producing device which produces audio samples or sound samples according to the specific frequency representative for the respective objects at different sound pressure levels, which means e.g. that for one and the same kind of objects sound samples or audio samples respectively are created by the sound sample producing device at different sound pressure levels. The actual sound pressure level of a specific sample is determined by the software or the audiologist depending on the answers of the test person in response to previous sound samples.

Further possible embodiments of the inventive arrangement are described within further dependent claims.

The invention shall be described in more details with reference to the attached figures, in which

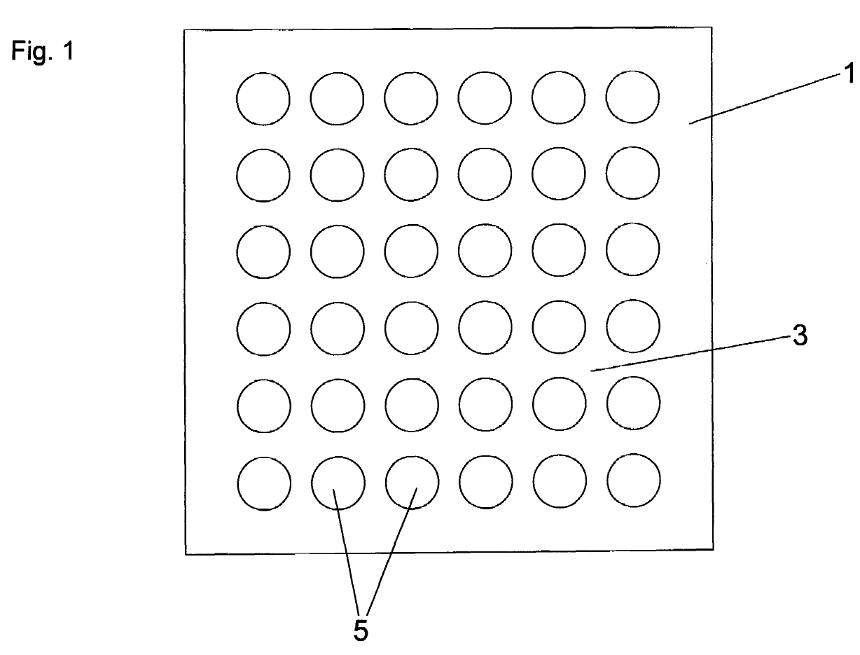

FIG. 1 shows schematically an inventive display or touch-screen for initiation of sound samples;

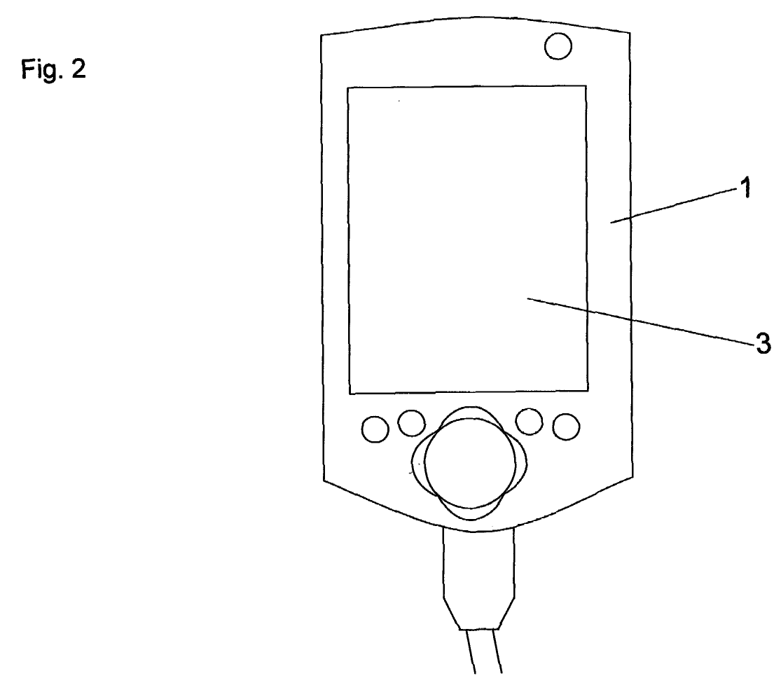

FIG. 2 a specific design of a touch-screen;

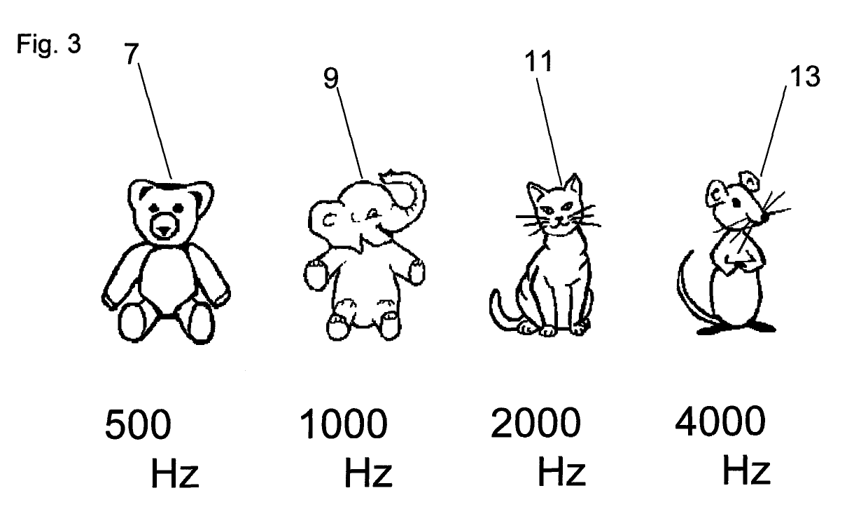

FIG. 3 shows schematically one example of a display or touch-screen respectively displaying various objects, each responsible for a certain frequency;

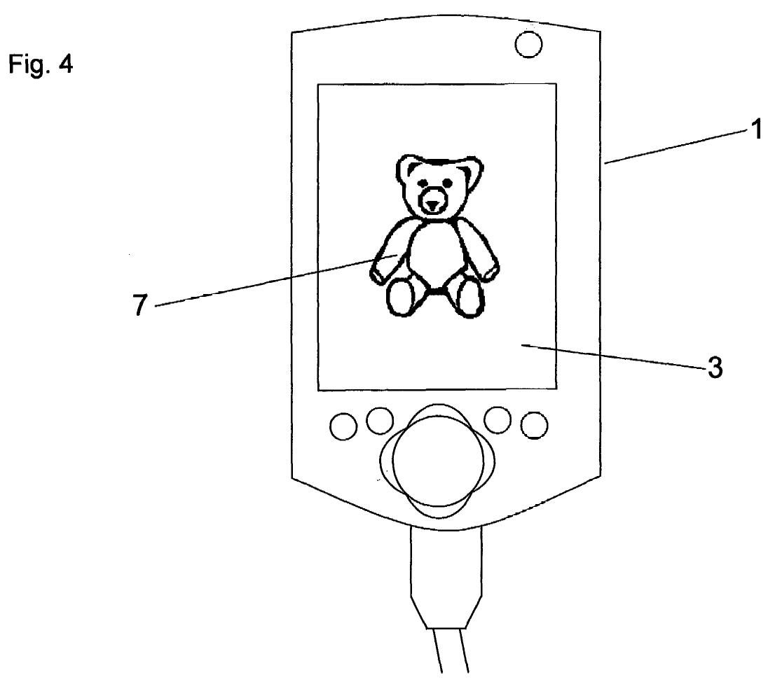

FIG. 4 shows the specific touch-screen of FIG. 2 displaying one object as shown in FIG. 3;

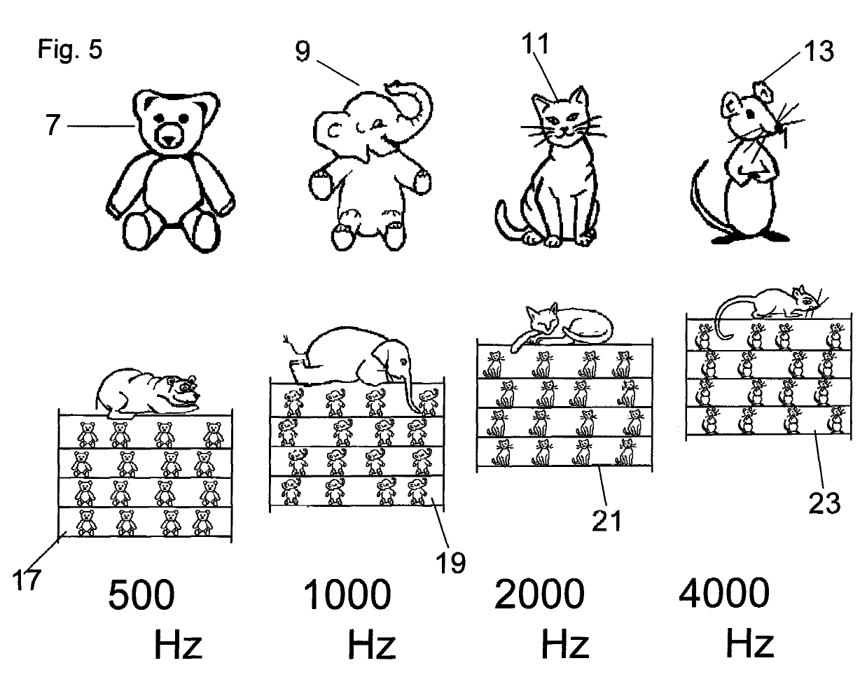

FIG. 5 shows the display of FIG. 3 indicating at the same time the number of sound samples to be initiated for each object;

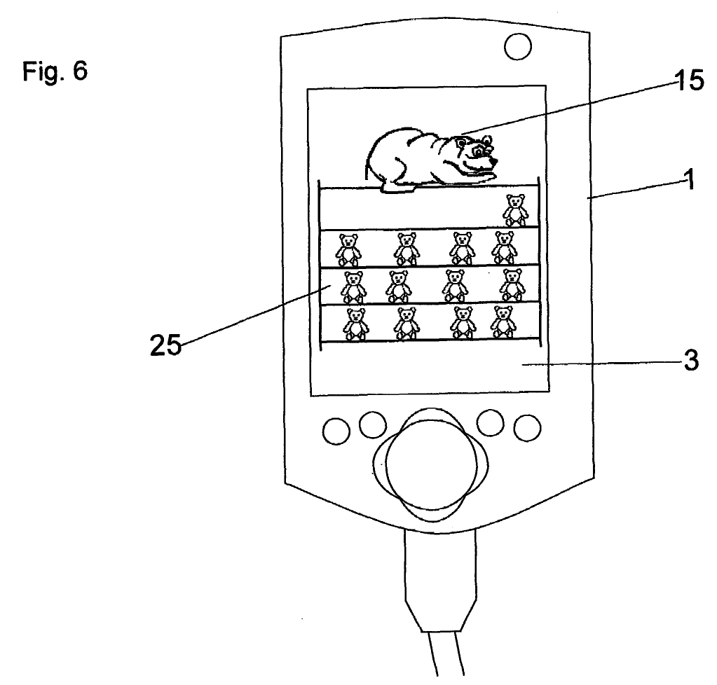

FIG. 6 shows the specific display according to FIG. 2 displaying one specific object out of FIG. 5 together with the amount of sound samples to be initiated;

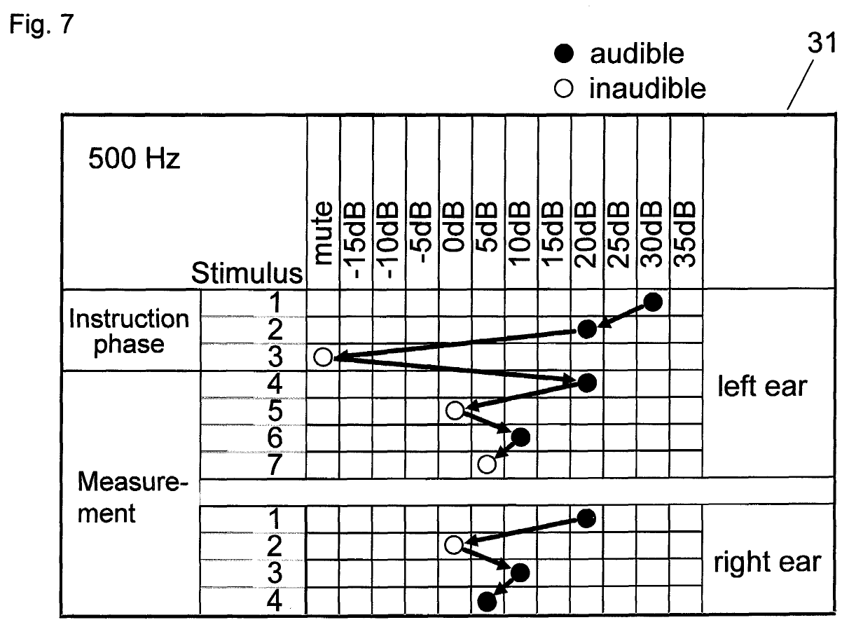

FIG. 7 shows schematically the execution of the inventive method displaying the results of the measurements;

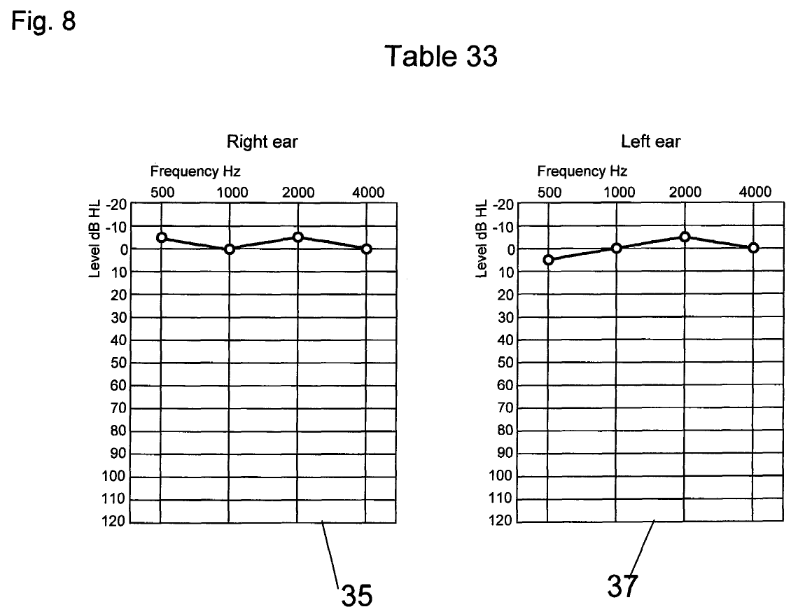

FIG. 8 shows schematically and by way of a diagram the results of the hearing measurement of a person with no hearing loss, and

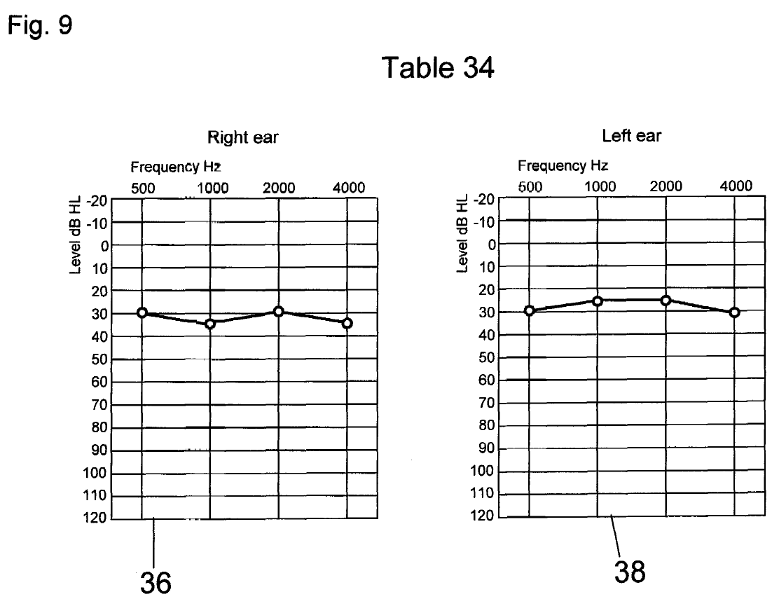

FIG. 9 shows by way of diagrams schematically the results of the measurement of a person having a hearing loss.

FIG. 1 shows schematically an inventive display 1 which is preferably a display screen or a touch screen 3 for initiating the sound samples. The person of which the hearing ability or the hearing loss respectively is to be determined can initiate the sound sample by pressing one of the push buttons 5 or the respective contact-sensitive area arranged on the touch-screen 3. In case of a computer display screen it is also possible to initiate the audio sample at a certain location by means of a cursor and a mouse click. On this display screen or touch-screen a plurality of locations, contact-sensitive areas or push buttons can be placed, each of the locations, buttons or areas being connected to a respective audio or sound sample-initiating arrangement to initiate the sound sample to be recognized by the person. The various locations, push buttons or contact areas may be neutral or anonymous as shown in FIG. 1 and only e.g. an audiologist being responsible for the diagnostic procedure knows which button or area respectively stands for which frequency and sound pressure. As mentioned above, the actual sound pressure level of a specific sample is determined by the software or the audiologist depending on the answers of the test person in response to previous sound samples.

FIG. 2 shows a specific possible design of an inventive display comprising a touch-screen 3, on which at least one contact area for initiating sound samples may be arranged.

Unlike the touch-screen shown in FIG. 2, FIG. 3 shows schematically one example of a display or touch-screen respectively displaying various objects, each being responsible for a certain frequency level. E.g. a teddy bear 7 can be displayed being representative for a sound sample of a 500 Hz frequency. In addition an elephant 9 can be displayed being representative for a sound sample with 1000 Hz frequency. Furthermore, a cat 11 being representative for a 2000 Hz frequency sample and finally a mouse 13 being representative for a 4000 Hz frequency sample.

As a consequence, e.g. on the device 1 as shown in FIG. 2 a respective object as e.g. a teddy bear 7 can be displayed on the touch-screen 3 to initiate a sound sample with 500 Hz frequency. Especially in the case of a child for which the hearing loss is to be determined, the arrangement of such kind of objects is preferred. The child touches the shown animal as the teddy bear 7 to check if it makes a tone or not. Each time the child touches the screen at the area of the teddy bear sound samples with a frequency of 500 Hz are initiated, each sample having a different loudness or sound pressure which is known to the audiologist or the diagnostic algorithm, respectively, and which is to be recognized or detected by the child.

Unlike the display shown in FIG. 4, where only one object is presented, it is of course also possible to show various objects similar to the display of FIG. 3 and at the same time displaying a plurality of touch-sensitive areas for each individual object. In other words, for the teddy bear 7, which means for a frequency of 500 Hz, e.g. sixteen contact-sensitive areas are arranged, which are schematically displayed within the area 17 shown on the touch-screen 3 in FIG. 5. In the same manner for the elephant 9 sixteen contact areas are arranged at 19 for initiating sound samples with a frequency of 1000 Hz. Again for the cat 11 e.g. sixteen contact-sensitive areas are arranged at 21 and sixteen contact-sensitive areas are arranged at 23, representative for the mouse 13, which means for initiating sound samples with 4000 Hz.

Turning back to the display sample as shown in FIG. 4 in the same manner the plurality of contact-sensitive areas can be arranged within the inventive display or the touch-screen respectively. In other words initially for a bear 15 sixteen respective contact-sensitive areas are arranged as shown in FIG. 6, which can be touched by the person of whom the hearing loss is to be determined. Each of the sixteen small bears arranged at 25 stands for a specific sound sample with a frequency of 500 Hz. As soon as a sample is being initiated by the person e.g. the respective symbol may disappear from the touch-screen 3 or may be dimmed. Dependent upon the response from the person it could also be that the symbol, such as a bear 15, may remain on the touch screen, which means that the sample has to be repeated. The reason for having a plurality of symbols is that by disappearing part of the symbols the progress can be made visible to the test person. Of course, instead of having a plurality of symbols, such as e.g. bears 15 as shown in FIG. 6, it is also possible to make the progress visible by using a bar-like scale. Therefore, e.g. always the same pushbutton can be used for performing the sound sample, and the progress is represented by e.g. a growing bar within the scale.

In FIG. 7 schematically the procedure of audiometric test sampling for one frequency is shown in form of a table. First, during an instruction phase, it is tested whether the test person of which the hearing loss is to be determined can operate the system in an appropriate manner. According to the table 31 as shown in FIG. 7, three test samples are being initiated by the user person during a so-called instruction phase. Test sample 1 at a frequency of 500 Hz is being initiated by the test person e.g. using a mouse and a cursor on a computer display by pressing a push button on a keyboard or by touching a contact-sensitive area on the touch-screen as described in FIG. 1-6.

Either the audiologist or an algorithm selects the levels of the sound samples to be initiated and to be recognized by the user person.

The first sound sample has a sound pressure level of 30 dB, the second sound sample one of 20 dB and the third sample is a mute sample to check, whether the sound sample-initiating test person is correctly recognizing the sound samples. As can be recognized from FIG. 7 the sample with a loudness of 20 dB still was audible by the user person, so that within the following measurement section loudness samples of 20 dB or lower should be initiated to be recognized by the user person. In other words the instruction phase can be important to determine the range of loudness of the samples for the following true measurement phase. But primary the instruction phase should ensure, that the test person has understood the procedure.

If the recognition of the samples during the instruction phase is completed and correct, the measurement first of the left ear and later on of the right ear or vice versa can be started. For each side as shown in FIG. 7 four samples have been used to determine the hearing ability of the test person. For the left ear the sound pressure samples with a level of 20 dB and 10 dB have been recognized by the user person, while the sound samples of 5 dB and 0 dB were not recognized. In other words the hearing ability stops between a level of 5 dB and 10 dB.

After the left ear measurement has been finished the same procedure shall be executed for the right ear, where according to the results as shown in FIG. 7 the hearing ability is somewhat better, as also the sound sample with a level of 5 dB was recognized by the user person. If the recognition of the samples is correct the measurement first of the left ear and later on of the right ear can be started. For each side four samples have been used to determine the hearing ability of the test person.

In FIG. 8 in table 33 the results of test sample series are shown for a person having a normal hearing ability, in diagram 35 the results are shown for the right ear, and in diagram 37 for the left ear. Similar to the test sampling procedure as shown in FIG. 7 again four measurement series for each frequency have been executed, for 500 Hz, 1000 Hz, 2000 Hz and 4000 Hz. As it can be recognized from both diagrams sound samples have been recognized by the user person with a level lower than 0 dB which leads to the conclusion that the user person has a normal hearing ability.

While in FIG. 8 the results are shown from a person with normal hearing ability, FIG. 9 shows the results in table 34 of a person having a substantial hearing loss. Again, diagram 36 includes the test results of the right ear at the four given frequencies and diagram 38 represents the test results for the left ear. For each frequency four different test series have been conducted. Unlike FIG. 8 the results as shown in diagram 36 and 38 lead to the conclusion that the user person suffers under a substantial hearing loss. This is due to the fact that sound samples e.g. at a frequency of 500 Hz with a sound pressure of 20 dB were not recognized by the user person. The border of recognition is somewhere in the area of approx. 30 dB.

The various examples of screens, displays or touch-screens as shown in FIG. 1-6 and tables in FIG. 7-9 illustrating test procedures and test results are only examples for better explaining and describing the present invention.

It is of course possible to modify the type of display or screen in any manner on which a user person can initiate the auditory sample to be recognized by the user person. It is even possible to use a simple push-button instead of a display or screen which can be operated by the user person to initiate the auditory sample. Furthermore, it is of course possible to work at less or more than four frequencies and to have less or more than four auditory samples for each frequency. In addition, the kind of objects to be displayed can be completely different from the objects shown within the samples as illustrated in FIG. 1-6.

The main point of the present invention is that at least most of the sound samples being used for the determination of the hearing ability or the hearing loss of a user person are initiated by the person itself and that the samples are generated in situ, which means within the hearing aid worn by the person.

1. Method for measuring the hearing ability or for the diagnosis of the hearing loss of a person, the method comprising the steps of initiating a plurality of sound samples to be recognized by said person, characterized in that at least most of the sound samples are initiated by said person and are generated in situ, which means within a hearing aid, middle ear implant or cochlear implant worn by the person.

2. Method according to claim 1, characterized in, that all sound samples are initiated by said person.

3. Method according to claim 1, characterized in that sound samples are initiated at different frequencies or for different sound types and different sound pressure levels respectively.

4. Method according to one of the claims 1 to 3, characterized in that the initiation of the sound samples is effected manually by the person by pressing a push button or touching a touch screen or the like.

5. Method according to one of the claims 1 to 3, characterized in that the initiation of the sound samples is effected by the person using a mouse and a respective cursor on a computer display, the sound sample being initiated by mouse click and the like, the cursor being arranged at the respective symbol for initiating the sample.

6. Method according to one of the claims 1 to 5, characterized in that at least one sound sample is initiated with a definitely inaudible sound pressure level for creating a so-called fake sample (blind sample).

7. Method according to one of the claims 1 to 6, characterized in that the initiation is effected on a computer display or touch screen displaying at least one object which stands for a certain sound frequency or sound type, upon touching or designating the object with e.g. a cursor, a sound sample with the said sound frequency or of said sound type is initiated.

8. Method according to one of the claims 1 to 7, characterized in that two or more objects are being displayed on the display or touch screen standing for certain sound frequencies or sound types, upon touching or designating one of the objects the sound sample with the respective frequency or of the respective sound type is being initiated by the person.

9. Method according to one of the claims 1 to 8, characterized in that for at least one frequency or sound type a plurality of objects is being displayed, the objects are representative for the said frequency or sound type and each individual object being responsible for the initiation of an individual sound sample for the said frequency or of said sound type.

10. Method according to one of the claims 1 to 9, characterized in that in an instruction phase for the auditory measurement or the diagnosis, respectively, the user person is initiating at least two sound samples for at least one frequency or sound type for determining the severity of the hearing loss, whereupon for each ear further sound samples are being initiated by the person for the at least said one frequency or sound type taking the severity of the hearing loss into consideration.

11. Method according to claim 9, characterized in that within the instruction phase for at least four frequencies or sound types at least two, preferably three or more sound samples are being initiated, whereupon the measurement for each ear is being executed for the at least four frequencies or sound types by initiating at least four sound samples for each frequency or sound type.

12. Arrangement for the diagnosis of a hearing loss of a user person comprising
a touch screen or computer display displaying at least one object which stands for a certain sound frequency or sound type,
a sound sample producing device or arrangement which is operable upon touching the object displayed on the touch screen or by moving and activating a cursor or the like on the computer display.

13. Arrangement according to claim 12, characterized in that a plurality of same objects for the certain sound frequency or sound type are being displayed on the touch screen or computer display.

14. Arrangement according to claim 12 or 13, characterized in that at least three, preferably four or more different objects are being displayed, each object standing for a certain sound frequency or sound type.
